(19) United States
(12) Patent Application Publication
(10) Pub. No.: US 2006/0000486 A1
(43) Pub. Date: Jan. 5, 2006

(54) Dental flossier

(76) Inventor: Barbara A. Davis, Cincinnati, OH (US)

Correspondence Address: Barbara Ann Davis, P.O. Box 53772, Cincinnati, OH, 45253-0772, US

(21) Appl. No.: 10/895,433

(22) Filed: Jan. 12, 2004

(51) Int. Cl. A61C 15/00

(52) U.S. Cl. 132/323

(57) ABSTRACT

The dental flossier has a flat handle that will make it easy to hold once it gets wet. The cloth or cloth like material for the floss strip will not only be wider it will also be impregnated with fluoride. The dental strip will be a one piece disposable unit. All parts will be sealed by the manufacturer. The tines will be attached to the handle by the manufacturer. The wide dental strip will be impregnated with fluoride and attached between the tines by the manufacturer.

After doing a thorough patent and trademark search, nothing was found to be similar to the dental strip.

The tape dispenser with the strip will be dispensed by pulling off sections to be placed between the fingers and between teeth moving the floss strip back and forth to remove food and leaving the fluoride as a protective coating to help prevent cavities.

This Is A Description Of A New Type Of Dental Flossier.

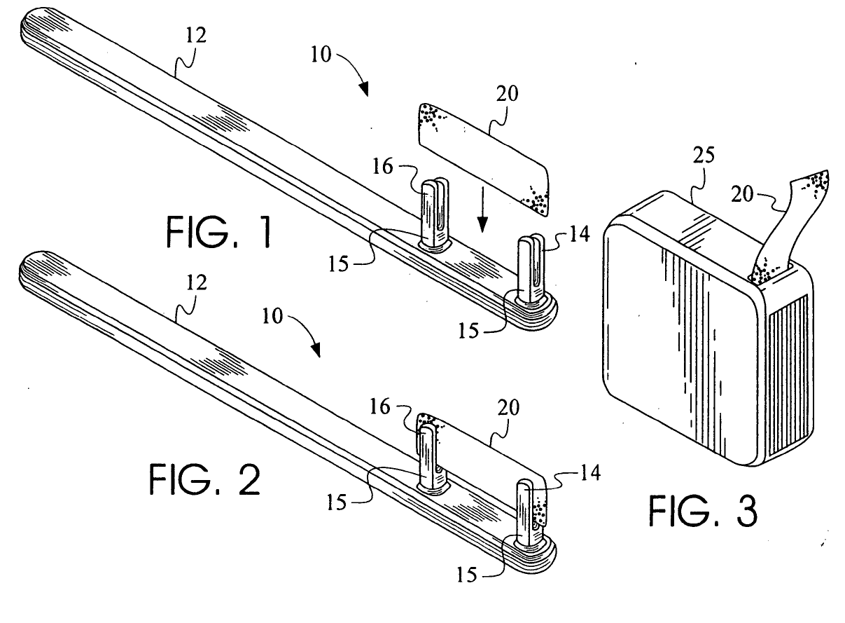

FIG. 1

10. The Dental Floss Strip. To Be Made Of Cloth Or Cloth-like Material.
12. Handle Made Of Plastic.
14. One Of 2 Tines. The Inside U-shaped To Hold The Floss Strip.
15. This Is The Base Of The Tines. They Are To Be Sealed By The Manufacturer To The Handle.
16. This Is The Outside Of The Tines. To Be Made Of Plastic Also.
20. Floss Strip. (1 Inch wide) (¼ Inch Height) Can Be Made In Various Sizes To Be Used By Adults & Children.
   FIG. 2
10. The Dental Floss Strip. To Be Made Of Cloth Or Cloth-like Material.
12. Handle Made Of Plastic.
14 One Of Two Tines. U-Shaped To Hold The Dental Floss Strip In Place As Pictured.
15. The Base Of The Tines
16. The Outside Of The Tines.
20. Floss Strip. (I Inch wide) (¼ Inch Height) Can Be Made In Various Sizes To Be Used By Adults & Children.
   FIG. 3
   The Dental Flossier In A Tape Dispenser.
20. Dental Floss Strip.
25. Tape Dispenser.
   The Dental Flossier was invented with a wider strip to:

1. Remove more food between teeth, while leaving a protective coating of fluoride.

2. The fluoride between teeth will help to prevent cavities between visits to the dentist.

3. Supported in writing by two reputable dentists.

4. “The cloth would be impregnated with fluoride”
“The fluoride would definitely help strengthen any weak areas in between the teeth.” “The inter-proximal surfaces of teeth tend to have signs of weak spots or the beginnings of decay if a person doesn't floss often or well.” “The new product will help strengthen any weak areas between teeth because of the fluoride.” “Her concept of a flat handle to help aid in hard to reach areas was wonderful.”
“I think her product is a wonderful invention.” Dr. Y. DDS

5. “It has a unique handle and a wide piece of cloth to help aid in cleaning the entire proximal surface of teeth.” “It is very easy to use.” The best part is that the dental flossier contains fluoride.” “The fluoride would aid in strengthening
